(19) United States
(12) Patent Application Publication
(10) Pub. No.: US 2023/0413001 A1
(43) Pub. Date: Dec. 21, 2023

(54) SIGNAL PROCESSING APPARATUS, SIGNAL PROCESSING METHOD, AND PROGRAM

(71) Applicant: SONY GROUP CORPORATION, TOKYO (JP)

(72) Inventors: TATSUSHI NASHIDA, TOKYO (JP); NAOMASA TAKAHASHI, TOKYO (JP); TATSUYA YAMAZAKI, TOKYO (JP)

(21) Appl. No.: 17/754,009

(22) PCT Filed: Sep. 16, 2020
(86) PCT No.: PCT/JP2020/035010

§ 371 Date: Aug. 11, 2023

(30) Foreign Application Priority Data
Sep. 30, 2019 (JP) 2019-179113

(51) Int. Cl. H04S 7/00; G10H 1/36; H04N 5/06

(52) U.S. Cl. CPC H04S 7/301; H04S 2420/01; H04N 5/06; G10H 1/368

(57) ABSTRACT

The present technology relates to a signal processing apparatus, a signal processing method, and a program each enabling reproduction of images and sounds in a synchronized manner. A signal processing apparatus includes a reproduction control unit configured to control, on the basis of image data of an image associated with a sound based on multichannel audio data, reproduction of the image, and a synchronization signal generation unit configured to generate a synchronization signal for reproducing the sound synchronized with the image on the basis of the multichannel audio data, on the basis of audio data for reproducing the sound, the audio data being smaller in number of channels than the multichannel audio data. The present technology is applicable to an omnidirectional contents reproduction system.

### TECHNICAL FIELD

The present technology relates to a signal processing apparatus, a signal processing method, and a program, and particularly relates to a signal processing apparatus, a signal processing method, and a program that enable synchronous reproduction of images and sounds.

### BACKGROUND ART

An object audio technology has conventionally been known, which achieves acoustic image localization to a given position in all directions at 360 degrees (hereinafter, such a technology will also be referred to as omnidirectional object audio) (see, for example, Non-Patent Document 1).

On the other hand, an omnidirectional video technology has also been proposed, which projects an image onto, for example, a dome-shaped screen, thereby displaying the image in all directions at 360 degrees (see, for example, Patent Document 1).

Reproducing contents using a combination of the omnidirectional video technology and the omnidirectional object audio allows users to enjoy the contents with high realistic feeling.

Hereinafter, such contents will also be referred to as omnidirectional contents, and the images and sounds in the omnidirectional contents will also be referred to as particularly omnidirectional video and omnidirectional audio.

### CITATION LIST

### Non-Patent Document

Non-Patent Document 1: ISO/IEC 23008-3 Information technology—High efficiency coding and media delivery in heterogeneous environments—Part 3: 3D audio

### Patent Document

Patent Document 1: WO 2018/101279 A1

### SUMMARY OF THE INVENTION

### Problems to be Solved by the Invention

Incidentally, the omnidirectional object audio needs to perform audio reproduction on the basis of, for example, audio data with multiple channels such as 32 channels.

In reproducing the omnidirectional contents, it is necessary to reproduce the omnidirectional audio and the omnidirectional video at the same time; therefore, this reproduction is made under high processing load.

In a case of utilizing as a reproduction apparatus a typical apparatus (a general-purpose system), such as a personal computer, rather than an expensive special-purpose system or the like, accordingly, it is occasionally necessary to prepare an apparatus for audio reproduction and an apparatus for video reproduction separately.

In such a case, it is necessary to achieve synchronization between the omnidirectional video and the omnidirectional audio for reproducing the omnidirectional contents.

However, the omnidirectional video data is different in data format from the omnidirectional audio data at present. In the case of reproducing the omnidirectional video and the omnidirectional audio using the different reproduction apparatuses, therefore, the omnidirectional video and the omnidirectional audio cannot be reproduced in a synchronized manner.

In view of such a circumstance, the present technology has been made for enabling synchronous reproduction of images and sounds.

### Solutions to Problems

A signal processing apparatus according to an aspect of the present technology includes a reproduction control unit configured to control, on the basis of image data of an image associated with a sound based on multichannel audio data, reproduction of the image, and a synchronization signal generation unit configured to generate a synchronization signal for reproducing the sound synchronized with the image on the basis of the multichannel audio data, on the basis of audio data for reproducing the sound, the audio data being smaller in number of channels than the multichannel audio data.

A signal processing method or a program according to an aspect of the present technology includes a step of controlling, on the basis of image data of an image associated with a sound based on multichannel audio data, reproduction of the image, and generating a synchronization signal for reproducing the sound synchronized with the image on the basis of the multichannel audio data, on the basis of audio data for reproducing the sound, the audio data being smaller in number of channels than the multichannel audio data.

According to an aspect of the present technology, on the basis of image data of an image associated with a sound based on multichannel audio data, reproduction of the image is controlled, and a synchronization signal for reproducing the sound synchronized with the image on the basis of the multichannel audio data is generated on the basis of audio data for reproducing the sound, the audio data being smaller in number of channels than the multichannel audio data.

### BRIEF DESCRIPTION OF DRAWINGS

FIG. 1 is a diagram illustrating an example of XML format metadata.

FIG. 2 is a diagram for explaining positional information contained in the metadata.

FIG. 3 is a diagram for explaining generation of omnidirectional video based on the metadata.

FIG. 4 is a diagram illustrating an external configuration example of an omnidirectional contents reproduction system.

FIG. 5 is a diagram for explaining a configuration of the omnidirectional contents reproduction system.

FIG. 6 is a diagram for explaining display of the omnidirectional video on a screen.

FIG. 7 is a diagram for explaining a configuration of an omnidirectional video file.

FIG. 8 is a diagram for explaining identification of an object type.

FIG. 9 is a diagram illustrating a functional configuration example of the omnidirectional contents reproduction system.

FIG. 10 is a flowchart for explaining reproduction processing.

FIG. 11 is a diagram illustrating a configuration example of a computer.

### MODE FOR CARRYING OUT THE INVENTION

Embodiments to which the present technology is applied will be described below with reference to the drawings.

### First Embodiment

### <About the Present Technology>

The present technology enables, in reproducing omnidirectional contents, synchronous reproduction of omnidirectional video and omnidirectional audio by generating a synchronization signal on the basis of audio data with smaller channels, the audio data corresponding to multichannel audio data of the omnidirectional audio.

Note that the omnidirectional contents may contain any omnidirectional video and any omnidirectional audio. In the following, a composition is described as the omnidirectional audio.

A typical composition is composed of sounds of a plurality of sound sources, such as a vocal sound and sounds of musical instruments such as a guitar. It is assumed herein that each sound source is regarded as a single audio object (hereinafter, simply referred to as an object) and audio data of a sound of each object (sound source) is prepared as audio data of the omnidirectional audio.

It is also assumed that the audio data of each object is associated with metadata containing positional information indicating the position of the object.

In this case, rendering processing is performed on the basis of the audio data of each object and the metadata, so that multichannel audio data is generated for reproducing the composition as the omnidirectional audio.

Then, when the composition is reproduced on the basis of the multichannel audio data, an acoustic image of each of the sounds of the objects (sound sources), such as the vocal sound and the sounds of the musical instruments, is localized to a position indicated by the positional information.

Furthermore, the omnidirectional video associated with the omnidirectional audio may be any image such as an image of a music video associated with the composition as the omnidirectional audio or an image generated on the basis of the audio data of the omnidirectional audio, or the like.

In the following, for example, the description is continued on the assumption that the image data (motion picture image data) of the omnidirectional video is generated on the basis of audio data smaller in number of channels than the multichannel audio data of the omnidirectional audio, the audio data being generated from each piece of audio data of the omnidirectional audio, or the multichannel audio data of the omnidirectional audio.

In general, materials for the omnidirectional audio such as the composition are for commercial use. For this reason, usually, there are stereo (two-channel) audio data, music video, and the like generated for distribution to users and the like and used for reproducing the composition or the like.

It is therefore possible to easily generate the image data of the omnidirectional video to be reproduced with the omnidirectional audio at the same time, on the basis of such stereo audio data or the like.

Next, a more specific description will be given of the present technology.

For example, a reproduction system has been proposed, which reproduces a composition and, simultaneously, projects and displays omnidirectional video associated with the composition onto and on a dome-shaped screen.

In such a reproduction system, two projectors are utilized for projecting the omnidirectional video onto the dome-shaped, that is, hemispherical screen, thereby displaying images associated with the composition.

Such a reproduction system is compatible with analog audio data input externally and a digital audio file with an extension “WAV” reproducible by a personal computer (hereinafter, also abbreviated as PC), as the audio data of the composition to be reproduced.

Then, the reproduction system analyzes a frequency band, a sound pressure level, a phase, and the like of the audio data of such a composition in real time. Then, a computer graphics (CG) image is generated on the basis of a result of the analysis, and the obtained CG image is reproduced as the omnidirectional video.

In the following, the scheme to perform the analysis processing on the audio data of the composition and to generate the CG image associated with the composition on the basis of the result of the analysis processing will also be referred to as an analysis and generation scheme.

According to the present technology, in addition to the generation and reproduction of the omnidirectional video, the reproduction of the omnidirectional contents is achieved by combining object-based omnidirectional object audio technologies. In the following, a system for reproducing such omnidirectional contents will be referred to as an omnidirectional contents reproduction system.

Here, an additional description will be given of the omnidirectional object audio.

In the omnidirectional object audio, sound sources, such as vocals, choruses, and musical instruments, that compose a composition (a music) are defined as objects, and positional information is added to each object. The sound sources (objects) can thus be arranged in all directions in a multichannel audio environment.

In the omnidirectional object audio, therefore, an artist or a creator can decide sound source configurations and arrangement of the respective sound sources on the basis of his/her musicality or creativity in producing contents.

The omnidirectional audio thus generated cannot be reproduced by a conventional stereo-based reproduction apparatus that performs L and R two-channel stereo reproduction. That is, an acoustic image cannot be localized to a given position in all directions at 360 degrees.

In order to reproduce the omnidirectional audio, it is necessary to convert the sound sources into multiple formats and to subject each sound source to rendering in accordance with positional information, such as a distance and an angle, indicating a position of the sound source.

Examples of a method of achieving the omnidirectional audio reproduction include wave field synthesis (WFS), vector base amplitude pannning (VBAP), and the like for replicating completely the same situation as a sound field assumed in producing omnidirectional audio, using a 32-channel speaker system.

The WFS, the VBAP, and the like to be performed as rendering processing allow an acoustic image of each sound source (object) to be accurately localized to a position determined from the distance and the angle indicated by the positional information decided in producing the contents. In other words, it is possible to accurately reflect a creative intension of a contents producer and to achieve replication of a sound field with high realistic feeling as if a user can hear sounds from all directions at 360 degrees.

Furthermore, a binaural reproduction technology or the like has also been known, which appropriately subjects sounds reaching the left and right ears of a user (listener) to signal processing, using a head-related transfer function as a model expression, thereby achieving omnidirectional object audio with a normal two-channel headphone.

In the omnidirectional contents reproduction system to which the present technology is applied, as described above, the cooperative use of the omnidirectional video technology and the omnidirectional object audio technology achieves the synchronous reproduction of the omnidirectional video, which is generated by, for example, the analysis and generation scheme, and the omnidirectional audio.

Note that the omnidirectional video is not limited to that generated by the analysis and generation scheme. For example, the omnidirectional video may be generated by an artist or a creator.

Incidentally, as described above, the audio data of each object and the metadata are generated as the omnidirectional audio data.

The audio data of each object and the metadata are generated in such a manner that, with regard to the composition and the respective objects such as the vocals, for example, an artist or a creator edits the audio data, the positions of the objects, and the like, using an authoring tool.

Note that the audio data of each object may be monophonic audio data or may be multichannel audio data.

For example, positional information indicating a position of each object and containing a distance from a listening position to the object and a direction of the object seen from the listening position is converted into meta-information through the edition by the artist or the creator using the authoring tool.

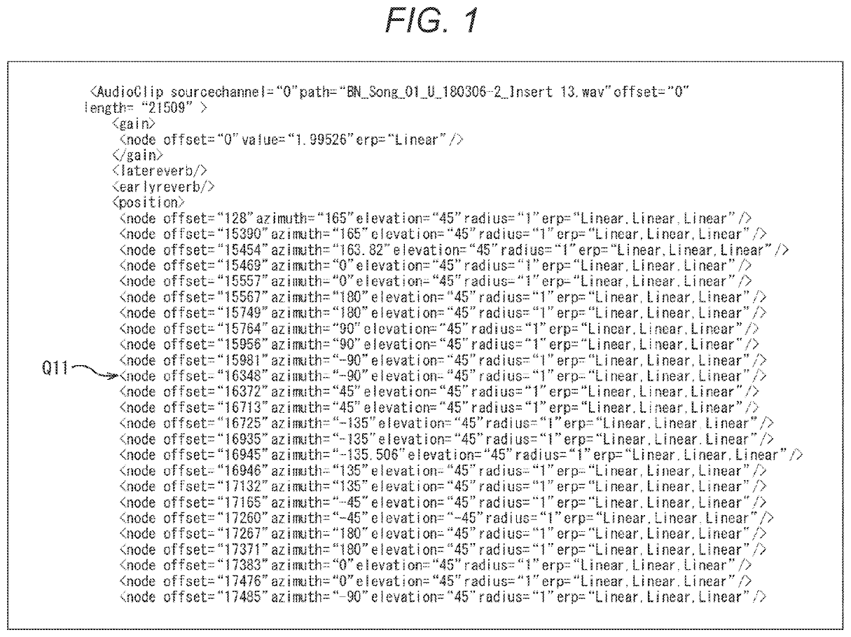

In this way, extensible markup language (XML) format metadata is obtained as illustrated in FIG. 1, for example.

In FIG. 1, a character string “BN_Song_01_U_180306-2_Insert 13.wav” represents audio data of an object associated with the metadata, that is, a file name of a sound source file.

Furthermore, in this example, positional information indicating a position of one object is arranged on a time-series basis every reproduction time. For example, a portion in one row, such as a portion indicated by an arrow Q11, corresponds to a tag indicating positional information at a certain time.

For example, an attribute name “node offset” in each tag is information convertible into time information during reproduction of omnidirectional audio as contents, and this information indicates an omnidirectional audio reproduction time.

Furthermore, attribute names “azimuth”, “elevation”, and “radius” in each tag respectively indicate an azimuth angle, an elevation angle, and a radius representing a position of an object at the reproduction time indicated by “node offset”.

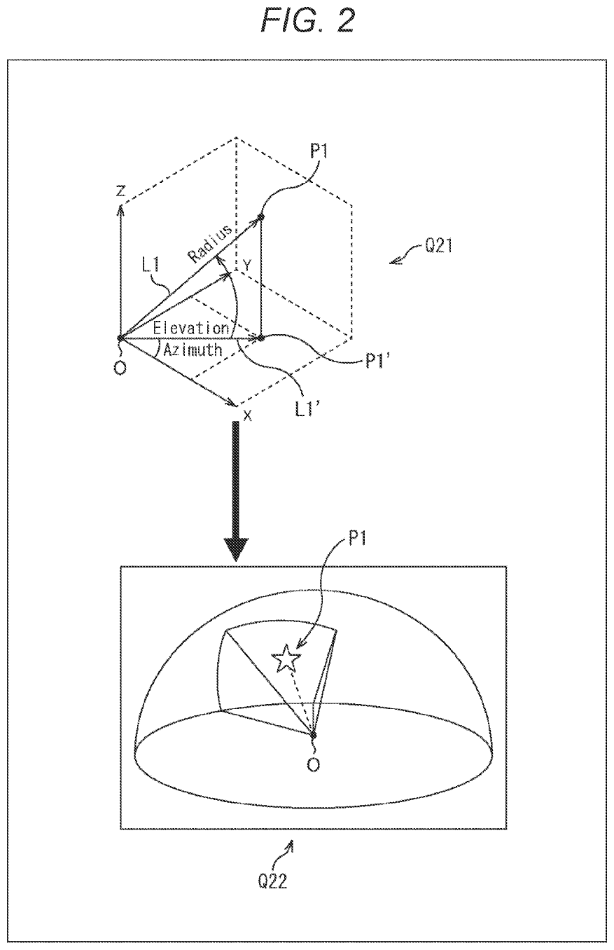

Particularly, here, as indicated by an arrow Q21 in FIG. 2, an object is arranged in a three-dimensional X-Y-Z space including an X axis, a Y axis, and a Z axis on condition that an origin O corresponding to a position of a listener is defined as a center.

For example, it is assumed that an object is arranged at a predetermined position P1 in the X-Y-Z space. At this time, it is assumed that a position P1′ refers to a position on the X-Y plane on (onto) which an image at the position P1 is displayed (projected), a straight line L1 refers to a straight line connecting the origin O and the position P1, and a straight line L1′ refers to a straight line connecting the origin O and the position P1′.

In this case, a horizontal angle indicating the position P1 seen from the origin O, that is, an angle formed by the X axis and the straight line L1′ is defined as an azimuth angle “azimuth”, and a vertical angle indicating the position P1 seen from the origin O, that is, an angle formed by the X-Y plane and the straight line L1 is defined as an elevation angle “elevation”. Furthermore, a distance from the origin O to the position P1, that is, a length of the straight line L1 is defined as a radius “radius”.

When the positional information containing the azimuth angle “azimuth”, the elevation angle “elevation”, and the radius “radius” indicating the position of each object is described in the metadata, three-dimensional spatial coordinates indicating the position of the object in the three-dimensional space can be obtained from the positional information as indicated by an arrow Q22. In this example, polar coordinates including an azimuth angle, an elevation angle, and a radius can be obtained as the three-dimensional spatial coordinates, for example.

As described above, the artist or the creator edits the position and the like of each object at each time, using the special-purpose authoring tool, thereby obtaining the XML format metadata containing the tags including “node offset”, “azimuth”, “elevation”, and “radius”. This metadata is an XML file with an extension “3dda”.

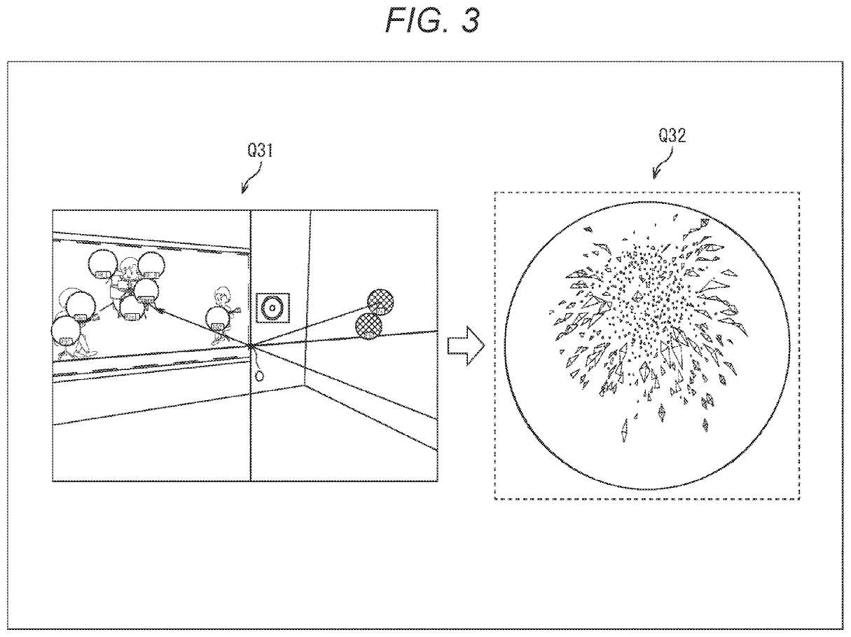

During the edit using the authoring tool, an edit screen indicated by an arrow Q31 in FIG. 3 is displayed, for example. In the edit screen, the origin O as the center position of the three-dimensional space corresponds to a position of a listener, that is, a listening position.

On such an edit screen, the artist or the creator arranges a spherical image representing each object (sound source) at a desired position in the three-dimensional space having the origin O as a center, thereby designating a position of the object at each time.

The foregoing XML format metadata is thus obtained, and the omnidirectional contents reproduction system can be achieved in such a manner that a space on the edit screen where each object (sound source) is arranged is directly linked with a space where omnidirectional image representation is performed, on the basis of this metadata.

Specifically, in the XML format metadata for each object in the omnidirectional audio, positional information indicating a position of the object is described in XML tags arranged on a time-series basis.

Therefore, for example, the positional information contained in the metadata can be converted by format conversion such as two-dimensional mapping into coordinate information indicating coordinates (a position) in an image space of the omnidirectional video. Therefore, it is possible to obtain coordinate information indicating a position of each object at each time in the image space of the omnidirectional video synchronized with the omnidirectional audio.

Accordingly, it is possible to generate the image data of the omnidirectional video by the foregoing analysis and generation scheme on the basis of the coordinate information thus obtained. Therefore, it is possible to obtain the image data of the omnidirectional video indicated by an arrow Q32, for example.

In this case, it is possible to obtain the coordinate information indicating the position in the image space corresponding to the object arrangement position decided by the artist or the creator. Using this coordinate information, therefore, it is possible to obtain image data of omnidirectional video that achieves more accurate image representation.

Specifically, a CG image and the like that evoke an object in the image space can be displayed at a position corresponding to the object in the image space, using the coordinate information, for example, and the image position can be made consistent with an acoustic image position of the object.

### <Configuration Example of Omnidirectional Contents Reproduction System>

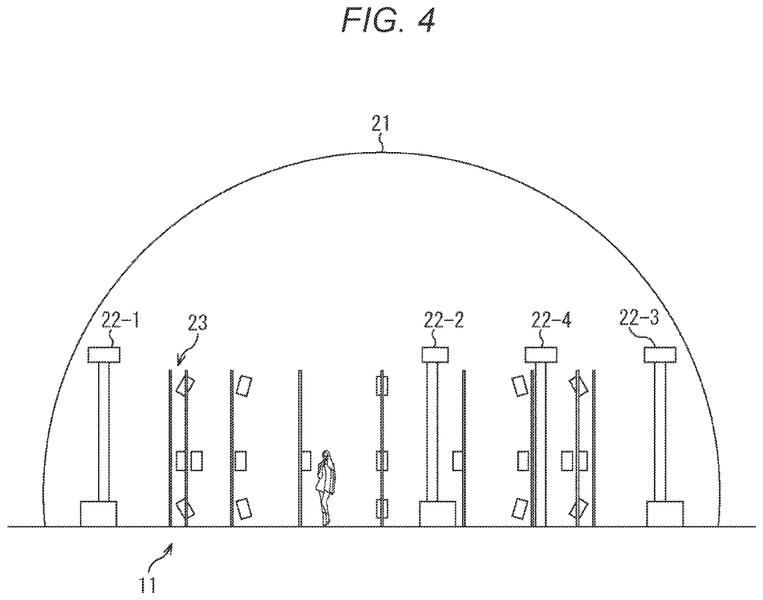

For example, FIG. 4 illustrates an external configuration of the omnidirectional contents reproduction system described above.

FIG. 4 illustrates an omnidirectional contents reproduction system 11 seen from the side.

In this example, the omnidirectional contents reproduction system 11 includes a dome-shaped screen 21, projectors 22-1 to 22-4 for projecting the omnidirectional video, and a speaker array 23 including a plurality of speakers, for example, 32 speakers.

Particularly, here, the projectors 22-1 to 22-4 and the speakers constituting the speaker array 23 are arranged inside the screen 21, that is, in a space surrounded by the screen 21, along the screen 21.

Note that, hereinafter, the projectors 22-1 to 22-4 may also be referred to as simply a projector 22 in a case where the projectors 22-1 to 22-4 are not necessarily distinguished from one another.

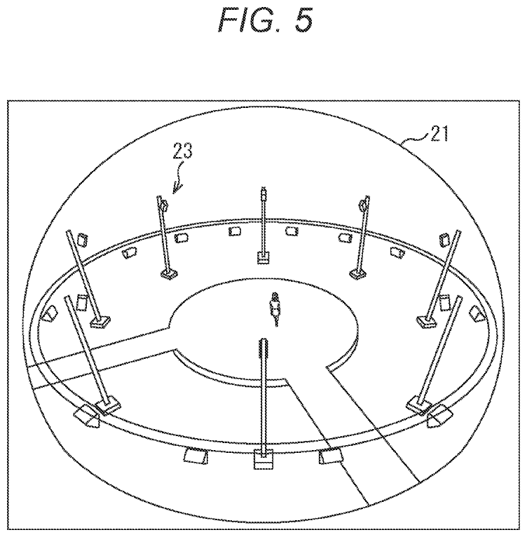

Furthermore, when the screen 21 is seen obliquely from above, as illustrated in FIG. 5, for example, a central portion of the space surrounded by the screen 21 is provided with a space where viewers/listeners can view/listen to the omnidirectional contents. Each viewer/listener can view/listen to the omnidirectional contents in any direction. Note that in FIG. 5, portions corresponding to those in FIG. 4 are denoted with the same reference signs, and the description thereof is omitted.

In the example illustrated in FIGS. 4 and 5, the speakers of the speaker array 23 are arranged so as to surround each viewer/listener. The speakers can output sounds toward the viewer/listener from all directions by reproducing the omnidirectional audio. That is, the acoustic image can be localized to a given position in all directions seen from the viewer/listener.

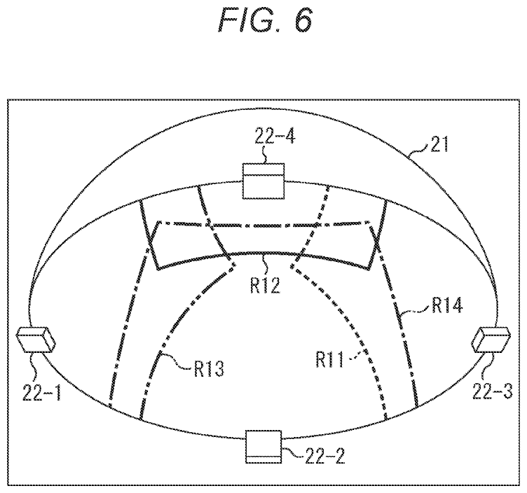

Moreover, in the omnidirectional contents reproduction system 11, as illustrated in FIG. 6, four projectors 22 project the images onto a region inside the screen 21 without gaps, thereby displaying the omnidirectional video in all directions seen from each viewer/listener.

Note that in FIG. 6, portions corresponding to those in FIG. 4 are denoted with the same reference signs, and the description thereof is appropriately omitted.

Here, the projector 22-1 projects the image onto a region R11 inside the screen 21, and the projector 22-2 projects the image onto a region R12 inside the screen 21.

Furthermore, the projector 22-3 projects the image onto a region R13 inside the screen 21, and the projector 22-4 projects the image onto a region R14 inside the screen 21.

Therefore, the images are displayed without gaps in the regions inside the screen 21, so that the omnidirectional video representation is achieved.

Note that, here, the example in which the omnidirectional contents reproduction system 11 includes four projectors 22 has been described. However, the omnidirectional contents reproduction system 11 may include any number of projectors 22. Likewise, the omnidirectional contents reproduction system 11 may include any number of speakers constituting the speaker array 23.

### <About Synchronization Between Omnidirectional Video and Omnidirectional Audio>

Incidentally, the omnidirectional contents reproduction system 11 reproduces the omnidirectional video and the omnidirectional audio at the same time. As described above, the omnidirectional audio is reproduced on the basis of the multichannel audio data.

For example, in a case where the speaker array 23 includes 32 speakers, the omnidirectional audio is reproduced on the basis of 32-channel multichannel audio data corresponding to these speakers. Therefore, this reproduction is made under increased processing load.

In this case, for example, a special-purpose PC or the like is typically required as a reproduction apparatus for reproducing the omnidirectional audio on the basis of the multichannel audio data.

On the other hand, as described with reference to FIG. 6, in the case where the omnidirectional video is reproduced using the plurality of projectors 22, one or more special-purpose PCs or the like are typically required.

As described above, separate apparatuses, such as special-purpose PCs, are required for the reproduction of the omnidirectional audio and the reproduction of the omnidirectional video, which require a mechanism for achieving synchronization between the reproduction of the omnidirectional audio and the reproduction of the omnidirectional video.

Hence, according to the omnidirectional contents reproduction system 11, the apparatus on the omnidirectional video reproduction side is configured to hold the audio data of the omnidirectional audio associated with the image data of the omnidirectional video and to generate a synchronization signal on the basis of the audio data.

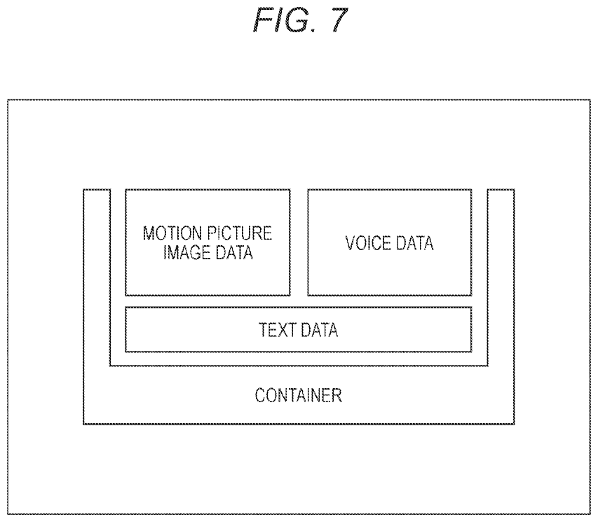

Specifically, for example, in an image format such as Moving Picture Experts Group 4 (MP4), a motion picture image file containing image data (motion picture image data) typically has a structure illustrated in FIG. 7.

In the example of FIG. 7, motion picture image data, voice data (audio data) of a voice accompanied with a motion picture image based on the motion picture image data, and text data such as subtitles correlated with the motion picture image data are stored in a container to form one motion picture image file.

In the omnidirectional contents reproduction system 11, for example, a motion picture image file in which the image data (motion picture image data) of the omnidirectional video and the audio data of the multidirectional audio corresponding to the omnidirectional video are stored in an associated manner is previously generated and is saved in the apparatus on the omnidirectional video reproduction side.

In the following, the motion picture image file in which the image data of the omnidirectional video and the audio data of the omnidirectional audio are stored in the associated manner is also referred as an omnidirectional video file. Furthermore, in the following, the audio data of the omnidirectional audio stored in the omnidirectional video file is also referred to as synchronous audio data.

Here, the synchronous audio data is audio data generated from the multichannel audio data for the reproduction of the omnidirectional audio, that is, the audio data for each object of the omnidirectional audio for use in rendering. Accordingly, for example, when sounds are reproduced on the basis of the synchronous audio data, the same sounds as sounds to be reproduced on the basis of the multichannel audio data of the omnidirectional audio are reproduced.

Particularly, the synchronous audio data is two-channel (stereo) audio data or the like smaller in number of channels than the multichannel audio data for the reproduction of the omnidirectional audio.

For example, the synchronous audio data may be generated at or after the edit of the omnidirectional audio, using the authoring tool.

That is, for example, the synchronous audio data may be generated on the basis of the audio data for each object of the omnidirectional audio. In this case, the synchronous audio data may be generated on the basis of the audio data of one of the objects.

Furthermore, the synchronous audio data may be generated by downmixing multichannel audio data obtained by performing the rendering processing on the basis of the audio data of each object.

For example, in a case where stereo audio data of the omnidirectional audio for music distribution or a compact disc (CD) is generated at the edit or after the rendering processing, this audio data may be used as the synchronous audio data.

Furthermore, the video data of the omnidirectional video stored in the omnidirectional video file can be generated on the basis of the synchronous audio data, for example.

For example, in a case where the artist or the creator produces the omnidirectional video, the omnidirectional video is produced in accordance with the positional information of each object (sound source), as an extension of the XML format metadata obtained by the edit. In producing the omnidirectional video, however, it is necessary to consider the omnidirectional audio, that is, a sound timing or the like in addition to this.

Hence, it becomes possible to obtain the omnidirectional contents on which the production intention is further reflected, by producing the omnidirectional video while actually reproducing the omnidirectional audio, on the basis of the synchronous audio data.

Furthermore, by the analysis and generation scheme, the omnidirectional video is generated by performing the analysis processing on the audio data for the reproduction of the omnidirectional audio, and the synchronous audio data may be utilized for the generation of this omnidirectional video. It is thus possible to obtain appropriate omnidirectional video without production work by the artist or the creator.

Anyway, it is possible to obtain an omnidirectional video file in which images and sounds are completely synchronized with each other as image contents, in such a manner that the synchronous audio data used for the generation of the omnidirectional video is associated with the image data of the omnidirectional video to form one file.

In the omnidirectional contents reproduction system 11, control is performed such that the omnidirectional video and the omnidirectional audio, which are reproduced by the different apparatuses, are synchronized with each other, on the basis of the omnidirectional video file generated in this way.

Specifically, with regard to, for example, the omnidirectional video, the omnidirectional video is only required to be reproduced as it is on the basis of the omnidirectional video file in which the images and the sounds are completely synchronized with each other, more specifically, the video data contained in the omnidirectional video file.

On the other hand, with regard to the omnidirectional audio, the synchronization signal is only required to be generated on the basis of the synchronous audio data contained in the omnidirectional video file such that the omnidirectional audio can be reproduced in synchronization with the omnidirectional video on the basis of the multichannel audio data of the omnidirectional audio.

Hence, in the omnidirectional contents reproduction system 11, on the basis of, for example, the synchronous audio data, a synchronization signal such as Word Clock is generated as an extension of the synchronous audio data. Note that the synchronous signal is not limited to Word Clock, and any signal may be used as long as it enables synchronous reproduction of the omnidirectional video and the omnidirectional audio.

When the synchronization signal is generated in this way, the synchronization signal is output to the apparatus on the omnidirectional audio reproduction side.

Then, the apparatus on the omnidirectional audio reproduction side performs control, such as pitch control (reproduction speed adjustment), on the basis of the supplied synchronization signal and, concurrently, reproduces the omnidirectional audio on the basis of the multichannel audio data. The omnidirectional video and the omnidirectional audio are thus reproduced in the completely synchronized state.

Note that here is the description of the example in which the omnidirectional video is the CG image generated by the analysis and generation scheme or the like. Alternatively, a CG image on which an image of a music video is superimposed may be reproduced as the omnidirectional video.

In such a case, however, the edit work of producing the omnidirectional video by superimposing the image of the music video on the CG image takes time and effort. Furthermore, it is difficult at the edit to accurately arrange the image of the music video at an appropriate position in the CG image.

Hence, for example, the XML format metadata of the omnidirectional audio is parsed to identify an object type of the omnidirectional audio, and an arrangement position (superimposition position) of the image of the music video in the CG image may be determined on the basis of a result of the identification.

It is thus possible to easily obtain the omnidirectional video in which the image of the music video is arranged at the appropriate position, without the troublesome edit work.

Specifically, it is assumed that, for example, “vocalist” is obtained as a result of the identification of the object type. In such a case, the image of the music video is superimposed on the CG image such that an image of a vocalist in the image of the music video is arranged at a position indicated by positional information of the object “vocalist”, that is, a position to which an acoustic image of the object “vocalist” is localized.

Note that the position of the vocalist in the image of the music video may be identified by, for example, image recognition or the like or may be manually designated in advance.

Furthermore, the object type, that is, a sound source (object) name can be identified from, for example, a name of a sound source file contained in the XML format metadata.

Specifically, for example, a sound source file having a name containing a text such as “Voice” or “Vocal” is identified as a sound source file regarding the object “vocalist”.

In addition, audio data of an object may be used for identification of an object type. Alternatively, the metadata and the audio data of each object may be used in combination.

For example, it is possible to identify a type of an object (sound source), such as a vocalist or a musical instrument, by performing analysis (examination) of a frequency (spectrum), a temporal waveform, a sound pressure level, a phase, and the like on the audio data of each object.

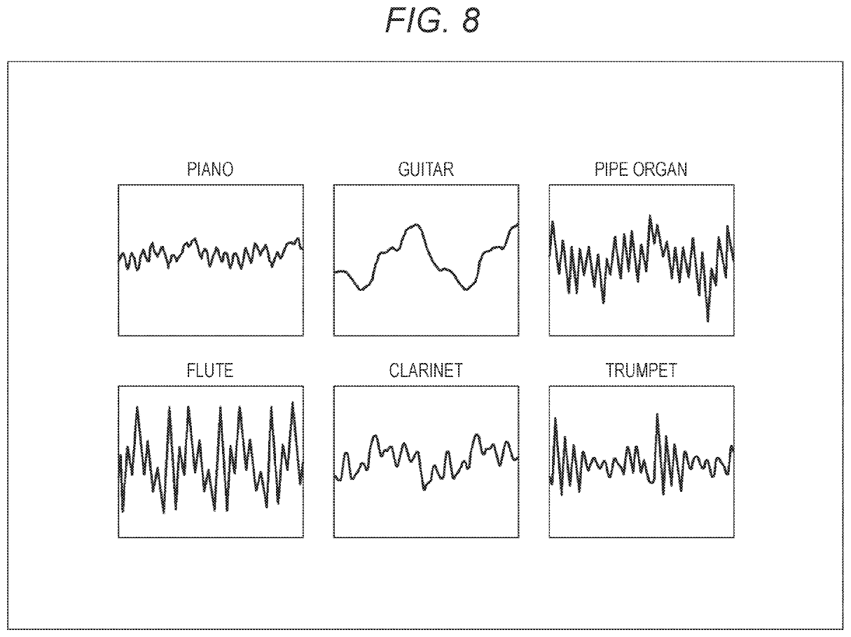

Specifically, frequency components and temporal waveforms contained in sounds are dependent on musical instruments as illustrated in FIG. 8, for example. FIG. 8 illustrates names of musical instruments as sound sources and temporal waveforms of sounds of the respective musical instruments.

It can be understood from this example that musical instruments have different characteristics, for example, the temporal waveform of a piano has a small change in amplitude and the temporal waveform of a flute has a large amplitude.

Accordingly, it is possible to distinguish (identify) each object type by performing the analysis processing on the audio data of each object.

As described above, according to the omnidirectional contents reproduction system 11, even when different apparatuses are used for the omnidirectional video and the omnidirectional audio in a case where the contents reproduction is made in combination of the omnidirectional video technology with the omnidirectional object audio, the omnidirectional video and the omnidirectional audio can be easily reproduced in a synchronized manner. Accordingly, for example, a general-purpose system such as a PC can be utilized for the reproduction of the omnidirectional video and the omnidirectional audio.

Furthermore, since the materials for the omnidirectional audio are typically for commercial use, there is two-channel audio data for distribution or the like or there is a music video corresponding to the omnidirectional audio, or the like in many instances as the audio data of the omnidirectional audio.

Hence, for example, when an image of a music video is superimposed on a CG image generated (produced) for the omnidirectional audio, the image processing is performed on the basis of metadata, two-channel (stereo) audio data, or the like. It is thus possible to save time and effort for the edit and the like and to easily obtain the omnidirectional video.

### <Functional Configuration Example of Omnidirectional Contents Reproduction System>

Next, a description will be given of a functional configuration and operations of the omnidirectional contents reproduction system 11 described above.

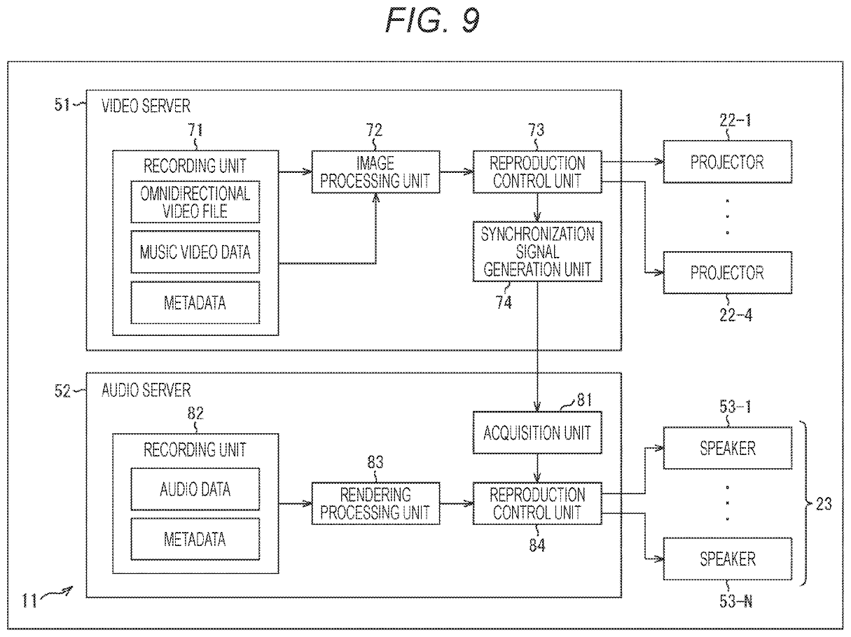

FIG. 9 is a diagram illustrating a functional configuration example of the omnidirectional contents reproduction system 11. Note that in FIG. 9, portions corresponding to those in FIG. 4 are denoted with the same reference signs, and the description thereof is appropriately omitted.

The omnidirectional contents reproduction system 11 illustrated in FIG. 9 includes a video server 51, projectors 22-1 to 22-4, an audio server 52, and a speaker array 23. Furthermore, although not illustrated in FIG. 9, the omnidirectional contents reproduction system 11 also includes a screen 21.

The video server 51 includes, for example, a signal processing apparatus such as a PC and functions as a reproduction apparatus configured to control the reproduction of the omnidirectional video.

The audio server 52 includes, for example, a signal processing apparatus such as a PC and functions as a reproduction apparatus configured to control the reproduction of the omnidirectional audio.

Particularly, here, the video server 51 and the audio server 52 are different apparatuses. The video server 51 and the audio server 52 are connected to each other with a wire or in a wireless manner.

The speaker array 23 includes N speakers 53-1 to 53-N. These speakers 53-1 to 53-N are arranged in a hemispherical form along the screen 21, for example. Note that, hereinafter, the speakers 53-1 to 53-N may also be referred to as simply a speaker 53 in a case where the speakers 53-1 to 53-N are not necessarily distinguished from one another.

Furthermore, the video server 51 includes a recording unit 71, an image processing unit 72, a reproduction control unit 73, and a synchronization signal generation unit 74.

The recording unit 71 includes, for example, a nonvolatile memory and the like. The recording unit 71 records the foregoing omnidirectional video file, the music video data, and the respective objects constituting the omnidirectional audio, that is, the XML format metadata of the multichannel audio data. These pieces of data are supplied to the image processing unit 72.

Here, the omnidirectional video file recorded in the recording unit 71 is an MP4 format file in which at least image data of omnidirectional video and synchronous audio data are stored.

Furthermore, the music video data is data for reproducing a music video associated with the omnidirectional audio. That is, here, the omnidirectional audio corresponds to a composition, and the music video data corresponds to data of a music video of the composition.

The music video data may be image data or may be data including image data and audio data. In the following, a description will be given of music video data including image data of a music video.

The image processing unit 72 performs image processing of superimposing the image of the music video on the omnidirectional video, on the basis of the omnidirectional video file, the music video data, and the metadata supplied from the recording unit 71, to generate image data of final omnidirectional video.

Furthermore, the image processing unit 72 supplies, to the reproduction control unit 73, the image data obtained from the image processing and the synchronous audio data extracted from the omnidirectional video file.

The reproduction control unit 73 controls the projector 22 on the basis of the image data and the synchronous audio data supplied from the image processing unit 72 and causes the projector 22 to project (output) light corresponding to the omnidirectional video onto (to) the screen 21, thereby controlling the reproduction of the omnidirectional video. The omnidirectional video is thus projected onto (displayed on) the screen 21 by the four projectors 22.

Furthermore, the reproduction control unit 73 supplies, to the synchronization signal generation unit 74, the synchronous audio data supplied from the image processing unit 72, while controlling the reproduction of the omnidirectional video. Note that the synchronous audio data may be supplied directly from the image processing unit 72 to the synchronization signal generation unit 74 without passing through the reproduction control unit 73.

The synchronization signal generation unit 74 generates a synchronization signal on the basis of the synchronous audio data supplied from the reproduction control unit 73, and supplies the synchronization signal to the audio server 52.

This synchronization signal is a signal indicating an omnidirectional audio reproduction timing for reproducing the omnidirectional audio in synchronization with the omnidirectional video on the basis of the multichannel audio data. For example, the synchronization signal generation unit 74 performs conversion processing of converting the format of the synchronous audio data, and the like to convert the synchronous audio data into a synchronization signal.

Furthermore, the audio server 52 includes an acquisition unit 81, a recording unit 82, a rendering processing unit 83, and a reproduction control unit 84.

The acquisition unit 81 is connected to the synchronization signal generation unit 74 with a wire or in a wireless manner. The acquisition unit 81 acquires the synchronization signal output from the synchronization signal generation unit 74 and supplies the synchronization signal to the reproduction control unit 84.

The recording unit 82 includes, for example, a nonvolatile memory and the like. The recording unit 82 records the audio data of each object of the omnidirectional audio corresponding to the image data of the omnidirectional video in the omnidirectional video file recorded in the recording unit 71 and the metadata of these objects in an associated manner. The metadata recorded in the recording unit 82 is the same as the metadata recorded in the recording unit 71. Each of these pieces of metadata is metadata of audio data of each object. It can also be said that each of these pieces of metadata is metadata of multichannel audio data obtained by the rendering processing based on these pieces of audio data.

The recording unit 82 supplies the recorded audio data and metadata to the rendering processing unit 83.

The rendering processing unit 83 performs the rendering processing on the basis of the audio data and the metadata supplied from the recording unit 82, and supplies, to the reproduction control unit 84, the multichannel audio data for reproducing the omnidirectional audio obtained as a result of the rendering processing.

Here, for example, filtering processing for WFS, VBAP, or the like is performed as the rendering processing, so that multichannel audio data is generated such that the acoustic image of the sound of each object is localized to the position indicated by the positional information in the metadata.

Particularly, since the speaker array 23 includes N speakers 53 in this example, multichannel audio data with N channels is generated by the rendering processing.

In other words, a signal group including speaker drive signals for the respective N speakers 53 for reproducing the sounds of the objects as the omnidirectional audio is generated as the multichannel audio data.

The multichannel audio data generated in this way is audio data for reproducing the omnidirectional audio associated with the omnidirectional video based on the image data in the omnidirectional video file recorded in the recording unit 71 of the video server 51.

At the same time, the multichannel audio data is, for example, audio data for reproducing the same sounds as the synchronous audio data in the omnidirectional video file recorded in the recording unit 71 of the video server 51. However, here, the synchronous audio data is audio data smaller in number of channels than the multichannel audio data.

Note that the rendering processing unit 83 may previously hold installation condition information indicating an installation condition of the screen 21 and may perform the rendering processing to correct the positional information contained in the metadata of the respective objects on the basis of the installation condition information.

Specifically, in a case where, for example, information indicating the radius of the hemispherical screen 21 is held as the installation condition information, the rendering processing unit 83 replaces a value of the radius indicated by the positional information of each object with a value of the radius indicated by the installation condition information. When the positional information is corrected in this way, the rendering processing is performed using the corrected positional information.

Further, the example in which the rendering processing is performed in the audio server 52 is described here. Alternatively, the rendering processing may be performed in advance and multichannel audio data obtained as a result of the rendering processing may be recorded in the recording unit 82.

In such a case, the multichannel audio data recorded in the recording unit 82 is supplied from the recording unit 82 to the reproduction control unit 84.

The reproduction control unit 84 performs processing, such as pitch control, on the basis of the synchronization signal supplied from the acquisition unit 81 and, concurrently, drives the speakers 53 on the basis of the multichannel audio data supplied from the rendering processing unit 83. The reproduction of the omnidirectional audio is thus controlled so as to be synchronized with the reproduction of the omnidirectional video.

### <Description of Reproduction Processing>

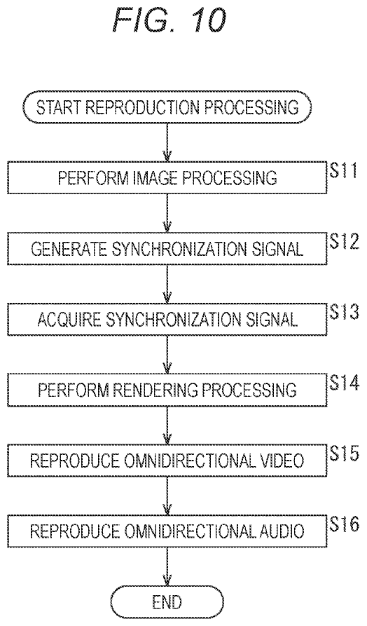

Next, a description will be given of the operations of the omnidirectional contents reproduction system 11 illustrated in FIG. 9. In the following, that is, a description will be given of the reproduction processing to be performed by the omnidirectional contents reproduction system 11 with reference to a flowchart of FIG. 10.

In step S11, the image processing unit 72 reads the omnidirectional video file, the music video data, and the metadata from the recording unit 71 and performs the image processing to generate image data of final omnidirectional video.

For example, the image processing unit 72 performs processing of generating image data of final omnidirectional video as the image processing by superimposing the image based on the music video data on the omnidirectional video based on the image data in the omnidirectional video file, on the basis of the positional information and the like contained in the metadata.

The image processing unit 72 supplies the image data of the final omnidirectional video thus obtained and the synchronous audio data in the omnidirectional video file to the reproduction control unit 73. Furthermore, the reproduction control unit 73 supplies the synchronous audio data supplied from the image processing unit 72 to the synchronization signal generation unit 74.

Note that the image processing unit 72 may perform, as the image processing, processing of generating the image data of the omnidirectional video by the analysis and generation scheme or the like, on the basis of at least one of the synchronous audio data, the metadata, or the music video data.

In such a case, the image data of the omnidirectional video can be obtained as long as the recording unit 71 records the synchronous audio data, the metadata, and the like even in a case where the recording unit 71 records no omnidirectional video file. Furthermore, the image of the music video may be superimposed on the omnidirectional video based on the image data generated by the analysis and generation scheme.

In step S12, the synchronization signal generation unit 74 generates, for example, a synchronization signal such as Word Clock on the basis of the synchronous audio data supplied from the reproduction control unit 73, and outputs the synchronization signal to the acquisition unit 81.

In step S13, the acquisition unit 81 acquires the synchronization signal output from the synchronization signal generation unit 74 in step S12, and supplies the synchronization signal to the reproduction control unit 84.

In step S14, the rendering processing unit 83 reads the audio data of each object of the omnidirectional audio and the metadata from the recording unit 82 and performs the rendering processing to generate multichannel audio data.

The rendering processing unit 83 supplies the multichannel audio data obtained from the rendering processing to the reproduction control unit 84.

In step S15, the reproduction control unit 73 causes the projector 22 to output light according to the image data on the basis of the image data and the synchronous audio data supplied from the image processing unit 72 to reproduce the omnidirectional video. The omnidirectional video is thus displayed on the screen 21.

In step S16, the reproduction control unit 84 performs processing such as pitch control on the basis of the synchronization signal supplied from the acquisition unit 81 and, concurrently, drives the speakers 53 on the basis of the multichannel audio data supplied from the rendering processing unit 83 to cause the speaker array 23 to reproduce the omnidirectional audio.

The processing tasks in steps S15 and S16 are carried out at the same time, so that the omnidirectional video and the omnidirectional audio are reproduced in the synchronized state.

In this way, when the omnidirectional contents including the omnidirectional video and the omnidirectional audio are reproduced, the reproduction processing ends.

As described above, the omnidirectional contents reproduction system 11 reproduces the omnidirectional video on the basis of the omnidirectional video file, generates the synchronization signal on the basis of the synchronous audio data in the omnidirectional video file, and reproduces the omnidirectional audio, using the synchronization signal.

By generating the synchronization signal on the basis of the synchronous audio data in this way, the omnidirectional video and the omnidirectional audio can be easily reproduced in a synchronized manner even in a case where the video server 51 and the audio server 52 are different apparatuses. That is, it is possible to reproduce images and sounds in the omnidirectional contents in a synchronized manner.

### <Configuration Example of Computer>

Incidentally, the foregoing series of processing tasks can be executed by hardware, and can also be executed by software. In a case where the series of processing tasks is executed by software, a program constituting the software is installed in a computer. Here, examples of the computer include a computer incorporated in dedicated hardware, a general-purpose personal computer, for example, capable of executing various functions by installing various programs, and the like.

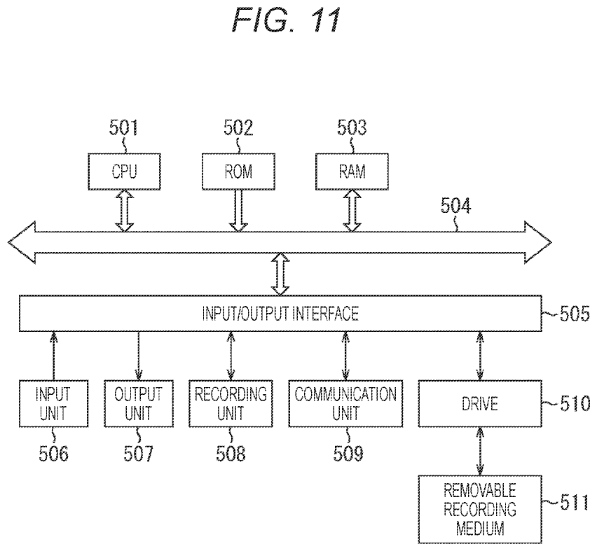

FIG. 11 is a block diagram illustrating a configuration example of hardware in a computer that installs therein the program to carry out the foregoing series of processing tasks.

In the computer, a central processing unit (CPU) 501, a read only memory (ROM) 502, and a random access memory (RAM) 503 are interconnected via a bus 504.

Moreover, an input/output interface 505 is connected to the bus 504. An input unit 506, an output unit 507, a recording unit 508, a communication unit 509, and a drive 510 are connected to the input/output interface 505.

The input unit 506 includes a keyboard, a mouse, a microphone, an imaging device, and the like. The output unit 507 includes a display, a speaker, and the like. The recording unit 508 includes a hard disk, a nonvolatile memory, and the like. The communication unit 509 includes a network interface and the like. The drive 510 drives a removable recording medium 511 such as a magnetic disk, an optical disk, a magneto-optical disk, or a semiconductor memory.

In the computer configured as described above, the CPU 501 loads, for example, a program recorded in the recording unit 508, onto the RAM 503 via the input/output interface 505 and the bus 504 to execute the program, thereby carrying out the foregoing series of processing tasks.

The program to be executed by the computer (the CPU 501) can be provided while being recorded in, for example, the removable recording medium 511 as a package medium or the like. Furthermore, the program can be provided via a wired or wireless transmission medium such as a local area network, the Internet, or digital satellite broadcasting.

In the computer, the program can be installed in the recording unit 508 via the input/output interface 505 in such a manner that the removable recording medium 511 is mounted to the drive 510. Furthermore, the program can be received at the communication unit 509 via a wired or wireless transmission medium, and can be installed in the recording unit 508. In addition, the program can be previously installed in the ROM 502 or the recording unit 508.

Note that the program to be executed by the computer may be a program by which processing tasks are carried out on a time-series basis in accordance with the sequence described in the present specification, or may be a program by which processing tasks are carried out in parallel or are carried out at a required timing such as a time when the program is called up.

Furthermore, embodiments of the present technology are not limited to the foregoing embodiments, and various variations can be made without departing from the gist of the present technology.

For example, the present technology can take a configuration of cloud computing in which a plurality of apparatuses processes one function via a network in collaboration with one another on a task-sharing basis.

Furthermore, the respective steps described with reference to the foregoing flowcharts can be executed by a single apparatus or can be executed by a plurality of apparatuses with the steps divided among the plurality of apparatuses.

Moreover, in a case where a single step includes a plurality of processing tasks, the plurality of processing tasks included in the single step can be carried out by a single apparatus or can be carried out by a plurality of apparatuses with the plurality of processing tasks divided among the plurality of apparatuses.

Moreover, the present technology may adopt the following configurations.

(1)

A signal processing apparatus including:
a reproduction control unit configured to control, on the basis of image data of an image associated with a sound based on multichannel audio data, reproduction of the image; and
a synchronization signal generation unit configured to generate a synchronization signal for reproducing the sound synchronized with the image on the basis of the multichannel audio data, on the basis of audio data for reproducing the sound, the audio data being smaller in number of channels than the multichannel audio data.
   (2)

The signal processing apparatus as recited in (1), in which
the multichannel audio data is data for reproducing a sound of an audio object.
   (3)

The signal processing apparatus as recited in (2), further including
an image processing unit configured to generate the image data of the image on the basis of at least one of image data of another image associated with the sound, metadata of the multichannel audio data, or the audio data.
   (4)

The signal processing apparatus as recited in (3), in which
the image processing unit performs analysis processing of a frequency band, a sound pressure level, or a phase on the audio data and generates the image data of the image on the basis of a result of the analysis processing.
   (5)

The signal processing apparatus as recited in (3) or (4), in which
the metadata contains positional information indicating a position of the audio object.
   (6)

The signal processing apparatus as recited in any one of (3) to (5), in which
the multichannel audio data is data for reproducing a composition, and
the other image is a music video of the composition.
   (7)

The signal processing apparatus as recited in (1) or (2), further including
an image processing unit configured to generate, on the basis of image data of another image associated with the sound, the image data of the image, and metadata of the multichannel audio data, image data of a new image including the image and the other image superimposed on the image,
in which
the reproduction control unit controls reproduction of the new image on the basis of the image data generated by the image processing unit.
   (8)

The signal processing apparatus as recited in (7), in which
the multichannel audio data is data for reproducing a composition, and the other image is a music video of the composition.
   (9)

The signal processing apparatus as recited in any one of (1) to (8), in which
the audio data is stored in a motion picture image file in which the image data of the image is stored.
   (10)

A signal processing method including:
causing a signal processing apparatus to control, on the basis of image data of an image associated with a sound based on multichannel audio data, reproduction of the image; and
causing the signal processing apparatus to generate a synchronization signal for reproducing the sound synchronized with the image on the basis of the multichannel audio data, on the basis of audio data for reproducing the sound, the audio data being smaller in number of channels than the multichannel audio data.
   (11)

A program causing a computer to execute processing including the steps of:
controlling, on the basis of image data of an image associated with a sound based on multichannel audio data, reproduction of the image; and
generating a synchronization signal for reproducing the sound synchronized with the image on the basis of the multichannel audio data, on the basis of audio data for reproducing the sound, the audio data being smaller in number of channels than the multichannel audio data.

### REFERENCE SIGNS LIST

11 Omnidirectional contents reproduction system
21 Screen
22-1 to 22-4, 22 Projector
23 Speaker array
51 Video server
52 Audio server
72 Image processing unit
73 Reproduction control unit
74 Synchronization signal generation unit
81 Acquisition unit
83 Rendering processing
84 Reproduction control unit

1. A signal processing apparatus comprising:
a reproduction control unit configured to control, on a basis of image data of an image associated with a sound based on multichannel audio data, reproduction of the image; and
a synchronization signal generation unit configured to generate a synchronization signal for reproducing the sound synchronized with the image on a basis of the multichannel audio data, on a basis of audio data for reproducing the sound, the audio data being smaller in number of channels than the multichannel audio data.

2. The signal processing apparatus according to claim 1, wherein
the multichannel audio data comprises data for reproducing a sound of an audio object.

3. The signal processing apparatus according to claim 2, further comprising
an image processing unit configured to generate the image data of the image on a basis of at least one of image data of another image associated with the sound, metadata of the multichannel audio data, or the audio data.

4. The signal processing apparatus according to claim 3, wherein
the image processing unit performs analysis processing of a frequency band, a sound pressure level, or a phase on the audio data and generates the image data of the image on a basis of a result of the analysis processing.

5. The signal processing apparatus according to claim 3, wherein
the metadata contains positional information indicating a position of the audio object.

6. The signal processing apparatus according to claim 3, wherein
the multichannel audio data comprises data for reproducing a composition, and
the other image comprises a music video of the composition.

7. The signal processing apparatus according to claim 1, further comprising
an image processing unit configured to generate, on a basis of image data of another image associated with the sound, the image data of the image, and metadata of the multichannel audio data, image data of a new image including the image and the other image superimposed on the image,
wherein
the reproduction control unit controls reproduction of the new image on a basis of the image data generated by the image processing unit.

8. The signal processing apparatus according to claim 7, wherein
the multichannel audio data comprises data for reproducing a composition, and
the other image comprises a music video of the composition.

9. The signal processing apparatus according to claim 1, wherein
the audio data is stored in a motion picture image file in which the image data of the image is stored.

10. A signal processing method comprising:
causing a signal processing apparatus to control, on a basis of image data of an image associated with a sound based on multichannel audio data, reproduction of the image; and
causing the signal processing apparatus to generate a synchronization signal for reproducing the sound synchronized with the image on a basis of the multichannel audio data, on a basis of audio data for reproducing the sound, the audio data being smaller in number of channels than the multichannel audio data.

11. A program causing a computer to execute processing including the steps of:
controlling, on a basis of image data of an image associated with a sound based on multichannel audio data, reproduction of the image; and
generating a synchronization signal for reproducing the sound synchronized with the image on a basis of the multichannel audio data, on a basis of audio data for reproducing the sound, the audio data being smaller in number of channels than the multichannel audio data.
